(19) United States
(12) Patent Application Publication
(10) Pub. No.: US 2004/0036899 A1
(43) Pub. Date: Feb. 26, 2004

(54) Image forming method, image processing apparatus, print producing apparatus and memory medium

(75) Inventors: Hiroaki Takano, Tokyo (JP); Tsukasa Ito, Tokyo (JP); Chizuko Ikeda, Tokyo (JP)

Correspondence Address: Muserlian, Lucas and Mercanti, 600 Third Avenue, New York, NY, 10016, US

(73) Assignee: Konica Corporation, Tokyo (JP)

(21) Appl. No.: 10/644,136

(22) Filed: Aug. 20, 2003

(30) Foreign Application Priority Data
Aug. 26, 2002 (JP) JP2002-245529

(51) Int. Cl. B41J 1/00; G06K 1/00

(52) U.S. Cl. 358/1.9

(57) ABSTRACT

An image forming method for forming visual image referred image data by subjecting captured image data to predetermined image processing of optimization. The method has the steps of: identifying a type of the image-capturing device; generating a scene-referred image data by subjecting the image data, obtained by photographing a subject having a reflection density of 0.7, to normalizing processing so that the reflection density on the output medium becomes 0.6 through 0.8; optimizing conditions of the predetermined image processing using the scene-referred image data; storing the optimized image processing conditions for each type of the image-capturing device; subjecting the image data to gradation compensation processing, which ensures that the average value of the image data is outputted to have the reflection density of 0.6 through 0.8 and γ values of the leg and the shoulder are smaller than that of the middle portion.

### BACKGROUND OF THE INVENTION

The present invention relates to an image forming method for creating the image data for desired high quality output through predetermined processing of digital image data obtained from an image-capturing device, an image processing apparatus based on this method, a print producing apparatus and a member medium.

(Prior Art)

The digital image data obtained by photographing with an image-capturing device is distributed through such a memory device as a CD-R (CD Recordable), floppy disk (registered trade name) and memory card or the Internet, and is displayed on such a display monitor as a CRT (Cathode Ray Tube), liquid crystal display and plasma display or a small-sized liquid crystal monitor display device of a cellular phone, or is printed out as a hard copy image using such an output device as a digital printer, inkjet printer and thermal printer. In this way, display and print methods have been diversified in recent years.

When digital image data is displayed and output for viewing, it is a common practice to provide various types of image processing typically represented by gradation adjustment, brightness adjustment, color balancing and enhancement of sharpness to ensure that a desired image quality is obtained on the display monitor used for viewing or on the hard copy.

In response to such varied display and printing methods, efforts have been made to improve the general versatility of digital image data. As part of these efforts, an attempt has been made to standardize the color space represented by digital RGB signals into the color space that does not depend on characteristics of an image-capturing device. At present, large amounts of digital image data have adopted the sRGB (See Multimedia Systems and Equipment Color Measurement and Management—Part 2-1: Color Management Default—RGB Color Space—sRGB” IEC61966-2-1) as a standardized color space. The color space of is sRGB has been established to meet the color reproduction area for a standard CRT display monitor.

A common digital camera is equipped with an imaging element (CCD type imaging element, hereinafter referred to as “CCD”) having a photoelectric conversion function with color sensitivity provided by a combination of a CCD (charge coupled device), a charge transfer device called a shift register and a mosaic color filter.

The digital image data output from the digital camera is obtained after the electric master signal gained by conversion via the CCD is subjected to compensation of the photoelectric conversion function of the imaging element (e.g. gradation compensation, spectral sensitivity stoke compensation, dark current noise control, sharpening, white balancing and chroma adjustment), and processing of file conversion and compression into the predetermined data format standardized to permit reading and display by image editing software.

Such a data format includes Baseline Tiff Rev. 6. RGB Full Color Image adopted as a non-compressed file of the Exif file (Exchangeable image file) and compressed data file format conforming to the JPEG (Joint Photographic Experts Group) format.

The Exif file conforms to the above-mentioned sRGB, and the compensation of the photoelectric conversion function of the above-mentioned imaging element is established so as to ensure the most suitable image quality on the display monitor conforming to the sRGB.

Generally, if a digital camera has the function of writing into the header of the digital image data the tag information for display in the standard color space (hereinafter referred to as “monitor profile”) of the display monitor conforming to the sRGB signal, and accompanying information indicating the information dependent on the device model such as the number of pixels, pixel arrangement and number of bits per pixel as meta-data and if only such a data format is adopted, the image edit software (e.g. Photoshop by Abode (registered trademark) for displaying the above-mentioned digital image data on the digital display monitor can analyze the tag information, prompt the operator to make conversion of the monitor profile into the sRGB, and carry out automatic processing of modification. This capability reduces the differences among different displays, and permits viewing of the digital image data photographed by the digital camera under the optimum condition.

In addition to the above-mentioned information dependent on model, the above-mentioned accompanying information includes the tags (codes) for showing the information directly related to the camera type (device model) such as a camera name and code number, exposure time, shutter speed, f-stop number, ISO sensitivity, brightness level, subject distance range, light source, on/off status a stroboscopic lamp, subject area, white balance, zoom scaling factor, subject configuration, photographing scene type, the amount of reflected light of the stroboscopic lamp source, photographing conditions such as chroma for photographing, subject type and so forth. The image edit software and output device are capable of reading the accompanying information and making the quality of hardware image more suitable.

### PROBLEMS TO BE SOLVED BY THE INVENTION

The image displayed by such a display device as a CRT display monitor and the hard copy image printed by various printing devices has different color reproduction areas depending on the configuration of the phosphor or color material. For example, the color reproduction area of the CRT display monitor compatible with the sRGB standard color space has a wide bright green and blue area. It contains the area that cannot be reproduced by the hard copy formed by a silver halide photographic printer, inkjet printer and conventional printer. Conversely, the cyan area of the conventional printing or inkjet printing and the yellow area of the silver halide photographic printing contain the area that cannot be reproduced by the CRT display monitor compatible with the sRGB standard color space. (For example, see “Fine imaging and digital photographing” edited by the Publishing Commission of the Japan Society of Electrophotography, Corona Publishing Co., P. 444). In the meantime, some of the scenes of the subject to be photographed may contain the color in the area that cannot be reproduced in any of these areas for color reproduction.

As described above, the color space (including the sRGB) optimized on the basis of display and printing by a specific device is accompanied by restrictions in the color gamut where recording is possible. So when recording the information picked up by a photographing device, it is necessary to make adjustment so as to compress the data to be accommodated into the color gamut where recording is allowed, and to carry out mapping. The simplest way is clipping where the chromaticity point outside the color gamut where recording is possible is mapped into the boundary of the nearest color gamut. This causes the gradation outside the color gamut to be collapsed, and the image will give a sense of incompatibility to the viewer. To avoid this problem, non-liner compression method is generally used. In this method, the chromaticity point in the area where chroma is high in excess of an appropriate threshold value is compressed smoothly according to the size of the chroma. As a result, at the chromaticity point inside the color gamut where recording is possible, chroma is compressed and recording is carried out. (For the details of the procedure of mapping the color gamut, see “Fine imaging and digital photographing” edited by the Publishing Commission of the Japan Society of Electrophotography, Corona Publishing Co., P. 479, for example).

The image displayed on such a display device as a CRT display monitor, the hard copied image printed by various types of printing devices or color space (including sRGB) optimized based on display and printing by these devices are restricted to the conditions where the area of brightness that allows recording and reproduction is of the order of about 100 to 1. However, it often happens that this area reaches the order of several thousands to 1. (See “Handbook on Science of Color, New Version, 2nd Print” by Japan Society for Science of Colors, Publishing Society of the University of Tokyo, P. 926, for example). Accordingly, when recording the information gained by the imaging device, compression is also necessary for brightness. In this processing, adequate conditions must be set for each image in conformity to the dynamic range of the scene to be photographed, and the range of brightness for the main subject in the scene to be photographed.

However, when compression has been carried out for the color gamut and brightness area as described above, the gradation information prior to compression or clipped information is lost immediately due to the principle of the digital image to be recorded in terms of the discrete value. The original state cannot be recovered. This imposes a big restriction on the general versatility of high-quality digital image.

For example, when the image recorded in the sRGB standard color space is printed, mapping must be carried out again based on the differences in the areas for color reproduction. However, at the time of recording, the information on gradation in the compressed area is lost, and the smoothness of gradation is deteriorated as compared to the case where the information gained by the photographing device is mapped directly in the area for color reproduction of the printing device. Further, if gradation compression conditions are not adequate at the time of recording, and there are problems such as a whitish picture, dark face, deformed shadow and conspicuous white noise in the highlighted area, improvement is very inadequate as compared to the case where the new image is created again from the information gained by the photographing device, even if the gradation setting is changed to improve the image. This is because information on gradation prior to compression, deformation or white noise is already lost.

The art of storing the process of image editing as a backup data and returning it to the state prior to editing whenever required has long been known. For example, the Japanese Application Patent Laid-open Publication No. 57047-1995 discloses a backup device wherein, when the digital image is subjected to local modification by image processing, the image data on the difference between the digital image data before image processing and that after image processing is saved as backup data. The Japanese Application Patent Laid-open Publication No. Hei 7-94778 discloses a method for recovering the digital image data before editing, by saving the image data on the difference between the digital image data before image processing and that after image processing. These technologies are effective from the viewpoint of preventing information from being lost, but the number of sheets to be photographed by a camera is reduced with the increase in the amount of data recorded in the media.

The problems introduced above are caused by the procedure where the information on the wide color gamut and brightness area gained by a photographing device is recorded after having being compressed into the visual image referred image data in the state optimized by assuming an image to be viewed. By contrast, if the information on the wide color gamut and brightness area gained by a photographing device is recorded as scene-referred image data that is not compressed, and then inadvertent loss of information can be prevented. The standard color space suited to record such scene-referred image data is proposed, for example, by RIMM RGB and ERIMM RGB (Journal of Imaging Science and Technology, Vol. 45 pp. 418 to 426 (2001)). However, the data expressed in the standard color space like the one described above, is not suitable for being displayed directly on the display monitor and viewed. Generally, a digital camera has a built-in display monitor or is connected to it in order for the user to check the angle of view before photographing or to check the photographed image after photographing. When photographed data is recorded, it can be displayed directly on the display monitor, without the data being converted. Despite this advantage, when the photographed data is recorded as scene-referred image data, the data must be subjected to the processing of re-conversion into the visual image referred image data in order to display that data. Such double processing of conversion inside the camera increases the processing load and power consumption, and causes the continuous shooting capability to be reduced, and imposes restrictions on the number of sheets to be shot in the battery mode.

The Japanese Application Patent Laid-open Publication No. Hei 11-261933 discloses an image processing apparatus characterized by two modes; a mode of recording in the form of an image signal displayed on the display means and a mode of recording in the form of photographed image signal. The form of image signal in the latter case is generally called RAW data. Using the special-purpose application software (called “development software”), such digital image data can be converted into visual image referred image data of the above-mentioned Exif file or the like for display or printing (called “electronic development” or simply “development”). Since the RAW data retains all information at the time of photographing, it permits visual image referred image data to be remade. If other color system files such as CMYK are created directly, there will no inadvertent modification of the color system due to the difference in color gamut from the display monitor (sRGB). However, the RAW data is recorded according to the color space based on the spectral sensitivity characteristics inherent to the model of the image-capturing device and the file format inherent to the. Accordingly, image suitable to display and printing can be obtained only when development software inherent to the type of the image-capturing device is used.

The Official Gazettes of Japanese Patents Laid-Open Nos. 16807/2002 and 16821/2002 disclose a method for providing a process image of higher quality wherein the model gradation characteristics curve for absorbing the model gradation characteristics of a digital camera is created for each type of the digital camera, independently of other gradation compensation curve, and influence of the gradation characteristics for each model of the digital camera can be removed by conversion using this model gradation characteristics curve.

This method is characterized in that printer AE (automatic exposure control) and AWB (automatic white balance control) are carried out after pre-processing of absorbing the model gradation characteristics profile of the digital camera, using the model gradation characteristics profile. However, when the present inventors have tried image processing of a great number of images according to this method, they have found out a problem in that gradation adjustment error is likely to occur in a closed-up view of a subject person or a photograph where the sky accounts for a greater percentage.

The analog printer adopts the exposure control algorithm (print exposure) where the average brightness of the entire image is set at a reflection density of 0.7 or at a reflection rate of 18% on the print. The subject corresponding to the reflection density of 0.7 or 18% is frequently reproduced at a higher lightness on the photographic print than it really is, although this may differ according to the composition of a picture. Generally, the skin color has the same reflection density and it tends to be reproduced at a higher lightness on the photographic print. As a result, the landscape looks bright and well defined, and is preferred subjectively, on the one hand. On the other hand, the face tends to be excessively bright with losing the reproduction of details. The digital printing technique for creating the silver halide photographic print from the scanned image of the negative by means of a digital exposure method is also based on the same exposure control algorithm, and provides a scene-dependent gradation reproduction very similar to that of the analog printer. Even if tag information or magnetic information is not utilized, control is possible to a certain extent: For example, the gradation reproduction can be slightly corrected, depending on whether a specific subject including skin color is included in the photographed scene. In this respect, the digital printer more easily allows optimization in conformity to the scene to be photographed.

The object of the present invention is to provide an image forming method, image processing apparatus, print producing apparatus and memory medium that reduce the difference in product quality from the photographic print and ensure more preferable print quality with high efficiency.

### SUMMARY OF THE INVENTION

The present inventors have strived for research and development, and have found out a new method based on a combination of at least two gradation control methods different in the degree of referring to the photographed scene, and a combination of compensations in conformity to the preference of a user and characteristics of an output medium.

To solve the above-mentioned problems, the present invention provides: (1) An image forming method for creating visual image referred image data by ensuring that the captured image data recorded by an image-capturing device is subjected to predetermined image processing of optimization to form an image for viewing on an output medium. This image forming method comprises: a step of identifying the type of the above-mentioned image-capturing device; a step of generating a scene-referred image data by ensuring that the image data obtained by photographing a subject having a reflection density of 0.7 is subjected to normalizing processing for each type of the image-capturing device so that the reflection density is 0.6 through 0.8 on the output medium;

a step of optimizing the above-mentioned predetermined image processing conditions using the above-mentioned scene-referred image data; a step of storing the optimized image conditions for each type of the image-capturing device; and a step of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(2) An image forming method for creating visual image referred image data by ensuring that the captured image data recorded by an image-capturing device is subjected to predetermined image processing of optimization to form an image for viewing on an output medium. This image forming method comprises: a step of identifying the type of the above-mentioned image-capturing device; a step of generating a scene-referred image data by ensuring that the image data obtained by photographing a subject having a reflection density of 0.7 is subjected to normalizing processing for each type of the image-capturing device so that the reflection density is 0.6 through 0.8 on the output medium; a step of optimizing the above-mentioned predetermined image processing conditions using the above-mentioned scene-referred image data and information on user's preference; a step of storing the optimized image conditions for each type of the image-capturing device; and a step of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(3) An image forming method for creating visual image referred image data by ensuring that the captured image data recorded by an image-capturing device is subjected to predetermined image processing of optimization to form an image for viewing on an output medium. This image forming method comprises: a step of identifying the type of the above-mentioned image-capturing device; a step of generating a scene-referred image data by ensuring that the image data obtained by photographing a subject having a reflection density of 0.7 is subjected to normalizing processing for each type of the image-capturing device so that the reflection density is 0.6 through 0.8 on the output medium; a step of optimizing the above-mentioned predetermined image processing conditions using the above-mentioned scene-referred image data and information on an output medium; a step of storing the optimized image conditions for each type of the image-capturing device; and a step of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(4) An image forming method for creating visual image referred image data by ensuring that the captured image data recorded by an image-capturing device is subjected to predetermined image processing of optimization to form an image for viewing on an output medium. This image forming method comprises: a step of identifying the type of the above-mentioned image-capturing device; a step of generating a scene-referred image data by ensuring that the image data obtained by photographing a subject having a reflection density of 0.7 is subjected to normalizing processing for each type of the image-capturing device so that the reflection density is 0.6 through 0.8 on the output medium; a step of optimizing the above-mentioned predetermined image processing conditions using the above-mentioned scene-referred image data, information on user's preference and an output medium; a step of storing the optimized image conditions for each type of the image-capturing device; and a step of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(5) An image forming method described in (2) or (4) characterized in that the above-mentioned information on user's preference is the information accompanying the image data.

(6) An image forming method described in (2) or (4) characterized in that the above-mentioned information on user's preference is the information entered by a user.

(7) An image forming method described in any one of items (2), (4), (5) and (6) characterized in that the above-mentioned information on user's preference is at least one of the pieces of information on the setting of image data gradation.

(8) An image forming method described in (3) or (4) characterized in that the above-mentioned information on an output medium is the information accompanying the image data.

(9) An image forming method described in (3) or (4) characterized in that the above-mentioned information on an output medium is the information entered by a user.

(10) An image forming method described in any one of items (3), (4), (8) and (9) characterized in that the above-mentioned information on an output medium is the information on the type and size of an output medium.

(11) An image forming method described in any one of items (1) through (10) characterized by utilizing the information specifically accompanying the image data on the type of the above-mentioned image-capturing device.

(12) An image forming method described in any one of items (1) through (11) characterized in that above-mentioned predetermined image processing includes at least one of gradation compensation and color compensation.

(13) An image processing apparatus for creating visual image referred image data by ensuring that the captured image data recorded by an image-capturing device is subjected to predetermined image processing of optimization to form an image for viewing on an output medium. This image processing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(14) An image processing apparatus for creating visual image referred image data by ensuring that the captured image data recorded by an image-capturing device is subjected to predetermined image processing of optimization to form an image for viewing on an output medium. This image processing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data and information on user's preference; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(15) An image processing apparatus for creating output-referred data by ensuring that the captured image data recorded by an image-capturing device is subjected to predetermined image processing of optimization to form an image for viewing on an output medium. This image processing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data and information on an output medium; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(16) An image processing apparatus for creating visual image referred image data by ensuring that the captured image data recorded by an image-capturing device is subjected to predetermined image processing of optimization to form an image for viewing on an output medium. This image processing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data, information on user's preference and information on an output medium; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(17) An image processing apparatus described in (14) or (16) characterized in that the above-mentioned information on user's preference is the information accompanying the image data.

(18) An image processing apparatus described in (14) or (16) characterized by comprising means (section) of acquiring information on user's preference, wherein the above-mentioned information on user's preference is the information entered by the user using the means (section) of acquiring information on user's preference.

(19) An image processing apparatus described in one of items (14), (16), (17) and (18) characterized in that the above-mentioned information on user's preference is the information includes at least one of the pieces of information on image data gradation setting.

(20) An image processing apparatus described in (15) or (16) characterized in that the above-mentioned information on an output medium is the information accompanying the image data.

(21) An image processing apparatus described in (15) or (16) characterized by comprising means (section) of acquiring information on an output medium, wherein the above-mentioned information on an output medium is the information entered by the user using the means (section) of acquiring information on an output medium.

(22) An image processing apparatus described in any one of items (15), (16), (17) and (21) characterized in that the above-mentioned information on an output medium contains at least one of the pieces of information on the type and size of the output medium.

(23) An image processing apparatus described in any one of items (13) through (22) characterized in that the means (section) of identifying the type of the image-capturing device identifies the type of the image-capturing device using the information accompanying the image data.

(24) An image processing apparatus described in any one of items (13) through (23) characterized in that the above-mentioned predetermined image processing includes at least one of gradation compensation processing and color compensation processing.

(25) A print producing apparatus for creating visual image referred image data by ensuring that the captured image data recorded by an image-capturing device is subjected to predetermined image processing of optimization to form an image for viewing on an output medium, and for producing a print by using this visual image referred image data. This print producing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(26) A print producing apparatus for creating visual image referred image data by ensuring that the captured image data recorded by an image-capturing device is subjected to predetermined image processing of optimization to form an image for viewing on an output medium, and for producing a print by using this visual image referred image data. This print producing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data and information on user's preference; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(27) A print producing apparatus for creating visual image referred image data by ensuring that the captured image data recorded by an image-capturing device is subjected to predetermined image processing of optimization to form an image for viewing on an output medium, and for producing a print by using this visual image referred image data. This print producing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data and information on an output medium; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(28) A print producing apparatus for creating visual image referred image data by ensuring that the captured image data recorded by an image-capturing device is subjected to predetermined image processing of optimization to form an image for viewing on an output medium, and for producing a print by using this visual image referred image data. This print producing apparatus comprises: means (section) of identifying the type of the above-mentioned image-capturing device; means (section) of generating a scene-referred image data by ensuring that the image data obtained by photographing a subject having a reflection density of 0.7 is subjected to normalizing processing for each type of the image-capturing device so that the reflection density is 0.6 through 0.8 on the output medium; means (section) of optimizing the above-mentioned predetermined image processing conditions using the above-mentioned scene-referred image data, information on user's preference and information on an output medium; means (section) of storing the optimized image conditions for each type of the image-capturing device; and means (section) of ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(29) A print producing apparatus described in (26) or (28) characterized in that the above-mentioned information on user's preference is the information accompanying the image data.

(30) A print producing apparatus described in (26) or (28) characterized by comprising means (section) of acquiring information on user's preference, wherein the above-mentioned information on user's preference is the information entered by the user using the means (section) of acquiring information on user's preference.

(31) A print producing apparatus described in any one of items (26), (28), (29) and (30) characterized in that the above-mentioned information on user's preference is the information includes at least one of the pieces of information on image data gradation setting.

(32) A print producing apparatus described in (27) or (28) characterized in that the above-mentioned information on an output medium is the information accompanying the image data.

(33) A print producing apparatus described in (27) or (28) characterized by comprising means (section) of acquiring information on an output medium, wherein the above-mentioned information on an output medium is the information entered by the user using the means (section) of acquiring information on an output medium.

(34) A print producing apparatus described in any one of items (27), (28), (32) and (33) characterized in that the above-mentioned information on an output medium contains at least one of the pieces of information on the type and size of the output medium.

(35) A print producing apparatus described in any one of items (25) through (34) characterized in that the means (section) of identifying the type of the image-capturing device identifies the type of the image-capturing device using the information accompanying the image data.

(36) A print producing apparatus described in any one of items (25) through (35) characterized in that the above-mentioned predetermined image processing includes at least one of gradation compensation and color compensation.

(37) A memory medium for storing a computer-readable program code for creating visual image referred image data by ensuring that the captured image data recorded by an image-capturing device is subjected to predetermined image processing of optimization to form an image for viewing on an output medium. This memory medium is characterized by storing the program comprising: a program code for identifying the type of the above-mentioned image-capturing device; a program code for generating a scene-referred image data by ensuring that the image data obtained by photographing a subject having a reflection density of 0.7 is subjected to normalizing processing for each type of the image-capturing device so that the reflection density is 0.6 through 0.8 on the output medium; a program code for optimizing the above-mentioned predetermined image processing conditions using the above-mentioned scene-referred image data; a program code for storing the optimized image conditions for each type of the image-capturing device; and a program code for ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(38) A memory medium for storing a computer-readable program code for creating visual image referred image data by ensuring that the captured image data recorded by an image-capturing device is subjected to predetermined image processing of optimization to form an image for viewing on an output medium. This memory medium is characterized by storing the program comprising: a program code for identifying the type of the above-mentioned image-capturing device; a program code for generating a scene-referred image data by ensuring that the image data obtained by photographing a subject having a reflection density of 0.7 is subjected to normalizing processing for each type of the image-capturing device so that the reflection density is 0.6 through 0.8 on the output medium; a program code for optimizing the above-mentioned predetermined image processing conditions using the above-mentioned scene-referred image data and information on user's preference; a program code for storing the optimized image conditions for each type of the image-capturing device; and a program code for ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(39) A memory medium for storing a computer-readable program code for creating output-referred data by ensuring that the captured image data recorded by an image-capturing device is subjected to predetermined image processing of optimization to form an image for viewing on an output medium. This memory medium is characterized by storing the program comprising: a program code for identifying the type of the above-mentioned image-capturing device; a program code for generating a scene-referred image data by ensuring that the image data obtained by photographing a subject having a reflection density of 0.7 is subjected to normalizing processing for each type of the image-capturing device so that the reflection density is 0.6 through 0.8 on the output medium; a program code for optimizing the above-mentioned predetermined image processing conditions using the above-mentioned scene-referred image data and information on an output medium; a program code for storing the optimized image conditions for each type of the image-capturing device; and a program code for ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

(40) A memory medium for storing a computer-readable program code for creating visual image referred image data by ensuring that the captured image data recorded by an image-capturing device is subjected to predetermined image processing of optimization to form an image for viewing on an output medium. This memory medium is characterized by storing the program comprising: a program code for identifying the type of the above-mentioned image-capturing device; a program code for generating a scene-referred image data by ensuring that the image data obtained by photographing a subject having a reflection density of 0.7 is subjected to normalizing processing for each type of the image-capturing device so that the reflection density is 0.6 through 0.8 on the output medium; a program code for optimizing the above-mentioned predetermined image processing conditions using the above-mentioned scene-referred image data, information on user's preference and information on an output medium; a program code for storing the optimized image conditions for each type of the image-capturing device; and a program code for ensuring that the image data obtained by applying the optimized image processing conditions is subjected to gradation compensation wherein the average value of image data is set in such a way that the reflection density is 0.6 through 0.8 on an output medium and “γ” of the leg (shaded portion) and shoulder (highlighted portion) is smaller than that of the middle portion, and then outputting that data.

### BRIEF DESCRIPTION OF THE DRAWINGS

FIG. 1 is a block drawing representing the functional configuration of an image processing apparatus 21a as an embodiment of the present invention.

FIG. 2 is a block drawing representing the functional configuration of an image processing apparatus 21b as an embodiment of the present invention.

FIG. 3 is a drawing representing how gradation is converted in the image forming method according to the present invention.

FIG. 4 is a flowchart representing the image formation carried out by an image processing apparatus 21a of FIG. 1 or image processing apparatus 21b of FIG. 2.

### DETAILED DESCRIPTION OF THE PREFERRED EMBODIMENT

The following describes the details of the embodiments of the present invention with reference to drawings. It should be noted, however, that the scope of the invention is not restricted to the illustrated examples given below.

The following describes the correspondence of components between the image processing apparatus or print producing apparatus of the present invention, and the image processing apparatuses 21a and 21b of the present embodiment. “Means (section) of identifying the type of the image-capturing device” of the image processing apparatus or print producing apparatus corresponds to the camera type identifying means (section) 3a and 3b of the image processing apparatuses 21a and 21b. “Scene-referred image data generating means (section)” of the present invention corresponds to normalizing processing means (section) 4a and 4b of the present embodiment. “Means (section) of optimizing the image processing conditions” of the present invention corresponds to condition optimizing means (section) 6a and 6b of the present embodiment. “Means (section) of storing” of the present invention corresponds to the condition storing means (section) 5a and 5b. “Means (section) of gradation compensation and outputting” of the present invention corresponds to visual image referred image data generating means (section) 20a and 20b, printers 14a and 14b, CRT monitors 18a and 18b and CD-R writing means (section) 19a and 19b of the present embodiment. “Predetermined image processing” of the present invention refers to processing carried out to correct the differences among varied types of the image-capturing device, as shown in the present embodiment. It contains gradation compensation, color compensation, sharpness processing and noise processing. Alternatively, as the type of the image-capturing device is identified, the scope of image processing can be extended to include the optical system of the image-capturing device, exposure control, gray balance adjustment and focus adjustment.

The configuration of the present embodiment will be described.

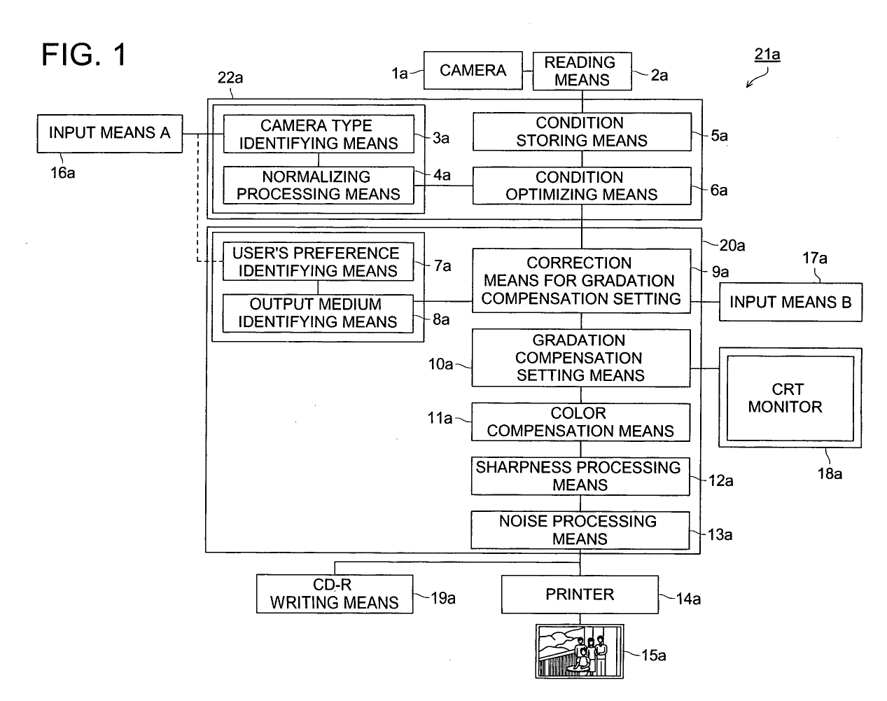

FIG. 1 is a block drawing representing the functional configuration of an image processing apparatus 21a as an embodiment of the present invention. As shown in FIG. 1, the image processing apparatus 21a comprises a digital camera 1a, reading means (section) 2a, scene-referred image data generating means (section) 22a, visual image referred image data generating means (section) 20a, printer 14a, input means (section) 16a and 17a, monitor 18a, CD-R writing means (section) 19a and others.

The digital camera 1a is an image-capturing device equipped with an imaging device (image sensor) having a photoelectric conversion function, and is used to obtain the captured image data of a subject. This imaging device is exemplified by a Charge Coupled Device (CCD), a CCD type imaging device with color sensitivity added through a combination of a charge transfer device (CTD) called shift register and a colored mosaic filter, and a CMOS type imaging device. The output current from those imaging devices is digitized by an analog-to-digital converter. The contents in each color channel in this phase represent signal intensities based on the spectral sensitivity inherent to the imaging device.

The above-mentioned captured image data of an subject is the digital image data, which has undergone image processing of modifying the data contents to improve the effect for image viewing such as gradation conversion, sharpness enhancement and chroma enhancement, and processing of mapping to the color space normalized for the above-mentioned RIMM RGB and sRGB, after the data digitized by the analog-to-digital converter as a raw output signal directly produced from the image-capturing device faithfully recording the information of the subject has been subjected to compensation of noises such as fixed pattern noise and dark current noise. The image-capturing device provided in the image processing apparatus 21a is not restricted to the digital camera 1a. It can be formed by a scanner equipped with the above-mentioned imaging device or the like.

The reading means 2a reads from the above-mentioned recording medium the captured image data photographed by the digital camera and recorded on the memory card or the like, and outputs it to the scene-referred image data generating means 22a.

The printer 14a ensures that the image data entered through a noise processing means 13 to be described later is formed into a toner image according to the electrophotographic method based on the infrared laser beam and projected light by LED (Light-Emitting Diode). Then the printer 14a transfers the toner image onto the print paper as a printing image, and ejects the paper as output.

Input means 16a reads the information on user's preference, output medium and camera type from the information accompanying the captured image data. The information accompanying the captured image data includes the numerical value and code value entered by the user using the setup menu or key, information directly reflected to the camera type (model) such as camera name and code number that are set for each camera, information indirectly related to the camera type such as that allows the camera type (model) to be estimated (from the tag information used only by a particular camera or the like), for example, tag (code) information on image-capturing conditions setting including the exposure time, shutter speed, f-stop number, ISO sensitivity, subject distance range, light source, lighting or non-lighting of stroboscopic lamp, zooming magnification, subject composition, photographed scene type, the amount of reflected light of stroboscopic light source and image-capturing chroma, and information on an subject.

The input means 17a is an input interface for the user to set the processing conditions, etc. To put it more specifically, information on user's preference and output medium is entered directly by an operator or user. Information on user's preference is the information on the setting of gradation for image data, for example. The information on output medium is the information on a display device such as an LCD (Liquid Crystal Display), CRT (cathode ray tube) and plasma display, and information on the type and size of the original for hard copy image generation such as silver halide photographic paper, inkjet paper and thermal printing paper. To put it more specifically, it includes information on the type and size of the print ordered by the user, for example, silver halide photographic print of L size 3.5R size (89×127 mm) (displayed as “photographic print” on the menu), A4-sized inkjet print, CD-R writing according to a predetermined resolution setting or index print of a predetermined size.

The monitor 18a consists of LCD, CRT or the like. Image data is displayed on the screen according to the display signal instruction entered from gradation compensation processing means 10a. The CD-R writing means 19a records on such a recording medium as a CD-R the image output from the noise processing means 13a to be described later.

The scene-referred image data generating means 22a comprises camera type identifying means 3a, normalizing processing means 4a, condition storing means 5a and condition optimizing means 6a.

Here the scene-referred image data refers to the image data without being subjected to image processing of modifying the data contents to improve the effect for image viewing such as gradation conversion, sharpness enhancement and chroma enhancement, wherein the signal intensity of each color channel based on the spectral sensitivity of the imaging device itself has already been mapped onto the standard color space such as RIMM RGB and ERIMM RGB. The scene-referred image data is the data having undergone compensation of the opto-electronic conversion function defined in ISO1452 (see “Fine imaging and digital photographing” edited by the Publishing Commission of the Japan Society of Electrophotography, Corona Publishing Co., P. 449).

The amount of information of the scene-referred image data (e.g. number of gradations) is preferred to be equal to or greater than the level required by the visual image referred image data to be described later. Example, if the steps of gradation for the visual image referred image data is 8 bits per channel, the steps of the gradation for the scene-referred image data is preferred to be equal to or greater than 12 bits per channel. More preferably, it should be 14 bits per channel, and still more preferably, 16 bits per channel.

The camera type identifying means 3a identifies the type of the image-capturing device (model) or grade using the image-capturing information data attached to the captured image data or stored as a file different from the captured image data, and the information extracted from the captured image data, and outputs it to the normalizing processing means 4a. Being “attached to the captured image data” signifies being recorded as tag information written into the header inside the captured image data. Known such data formats include “Baseline Tiff Rev. 6. RGB Full Color Image” adopted as a non-compressed file of the Exif file and compressed data file format conforming to the JPEG, for example.

When the memory medium 23 to be described later has no optimization processing conditions, the normalizing processing means 4a reads the normalizing processing conditions from the memory medium 23 and performs normalization. Here the normalizing processing conditions are not the ones set up for each model, but they are the ones made for each manufacturer and stored in the memory medium 23 in advance.

To put it more specifically, the normalizing processing means 4a ensures that the image data obtained by photographing a subject having a reflection density of 0.7 is subjected to normalizing processing for each type of the image-capturing device so that the reflection density is 0.6 through 0.8 on the output medium. In other words, the gradation setting of the in digital printer is fixed for each camera, wherein adjustment (of a fixed point) is made to ensure that the reflection density of the gray standard patch reproduced on the photographic print is 0.6 through 0.8 (when the subject has a reflection density of 0.7) at all times or the reflection rate is 14 through 22% (when the subject has a reflection rate of 18%) at all times, when a gray standard patch having a reflection density of 0.7 or reflection rate of 18% is used as a subject and a photographic print is created from the image data obtained by a digital camera 1a using a digital printer. The reflection density reproduced on the photographic print is preferred to be 0.65 through 0.75, and the reflection rate is preferred to be 16 through 20%.

The reflection density and reflection rate differ according to the spectral sensitivity of the light source of a measuring instrument or filter. The spectral sensitivity of the light source or filter is tested in conformity to the measurement conditions of JIS (K: Photographic material, Chemicals and Measuring Method) and JIS (B: Optical Equipment). In this Specification, the reflection density and reflection rate are given in terms of value obtained for each of red (R), green (G) and blue (B) or the average value for RGB.

The normalizing processing means 4a can be so arranged that normalization processing is carried out for each of the photographing conditions for photographing a subject having a reflection density of 0.7, and normalizing processing conditions are selected in conformity to the photographing conditions. In this case, photographing conditions can be identified by either the method of manual entry by the user or the method of reading the tag information accompanying the image data. Here photographing conditions include use/non-use of a stroboscopic lamp, color temperature, and photographing mode such as undershooting, overshooting or portrait modes.

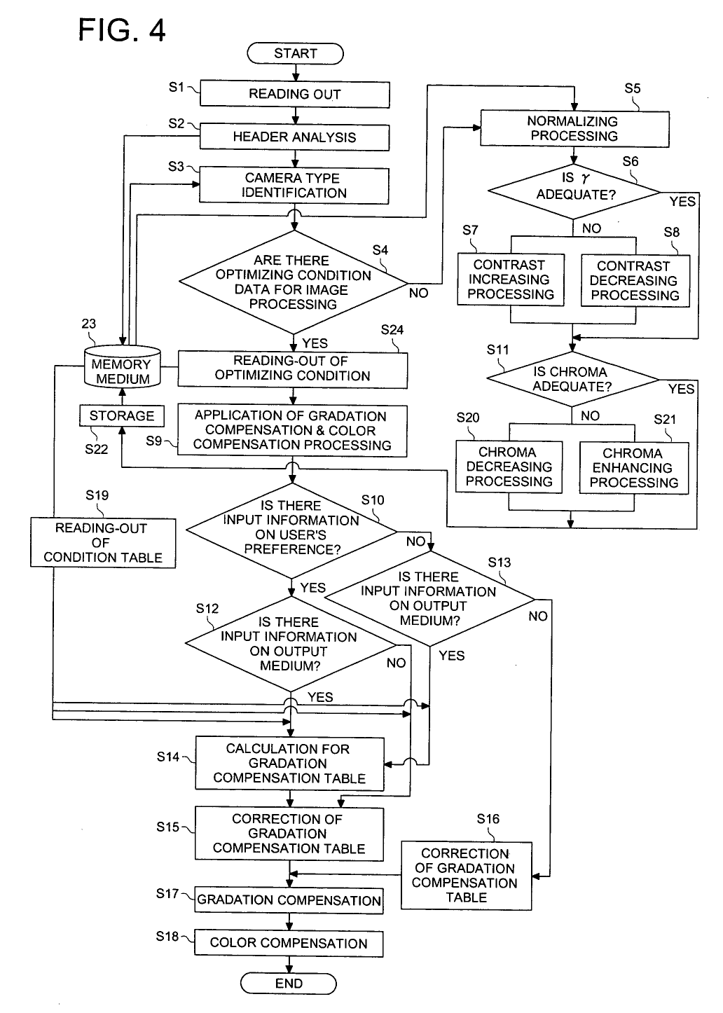

The condition storing means 5a has a memory medium 23 (see FIG. 4), and stores into the memory medium 23 the optimization processing conditions including the gradation compensation processing conditions and color compensation processing conditions that have been optimized by the condition optimizing means 6a. To put it more specifically, the condition storing means 5a stores into the memory for each camera type the data on gradation characteristics curve created using multiple gray pixels extracted from one or more items of image data, and color compensation parameter. This allows optimization of the image processing conditions to be carried out in conformity to the amount of image processed, with the result that higher precision can be ensured. As the camera is identified, the optical system of the image-capturing device, exposure control, gray balance adjustment and focus adjustment can be subjected to image processing. In other words, these image conditions are also included in the data stored for each camera type. Further, in the present invention, the tag (code) information recorded in the header of the image data can be stored as related information.

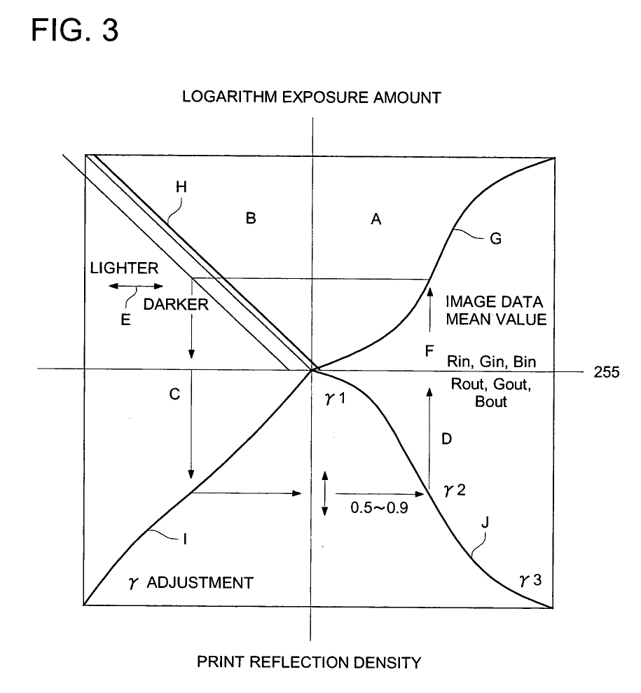

The following describes the details of the gradation conversion table (LUT). FIG. 3 is a drawing explaining how to set the gradation conversion table (LUT) in the image formation method of the present invention.

As shown in FIG. 3, the curve (G) of the first quadrant (A) is used to get the amount of logarithmic exposure from the camera gradation characteristics after processing of normalization has been carried out to ensure that the image of a subject having a reflection density of 0.7 has a reflection density of 0.6 through 0.8 on the output medium. The straight line (H) of the second quadrant (B) is intended to adjust the brightness of the entire image and the gray balance. Adjustment is made by parallel movement in the direction marked by an arrow (E) (hereinafter referred to as “LUT parallel movement”). The curve I of the third quadrant (C) adjusts the γ of the entire image (hereinafter referred to as “γ decrease or γ increase”). The curve (J) of the fourth quadrant is indicates the gradation characteristics reproduced on the print by non-linear compensation.

Point F indicated by the arrow mark on the curve (G) indicates the average value of image data (Rin, Gin and Bin). This point shows that the brightness on the print is adjusted (E) on the print by the straight line (H) of the second quadrant (B). When the gradation characteristics reproduced on the print is corrected by the curve I of the third quadrant (C) and the y of the leg (shaded area), middle portion and shoulder (highlighted portion) of the curve (J) is adjusted, then a desired gradation characteristics on the print can be obtained by setting the γ1 (leg (shaded portion) γ), γ2 (middle portion γ) and γ3 (shoulder portion (highlighted portion) γ) shown in curve (J) to a desired value.

In the present invention, the γ of the curve (J) is set in such a way that γ1 and γ3 of the leg (shaded portion) and shoulder (highlighted portion) are smaller than γ3 of the middle portion. The average value of the image data (Rin, Gin and Bin) can be worked out as follows: For example, adjacent pixels where hue and chroma are close to each other are picked up as one group, and the overall density is calculated from the simple average and the number of the pixels in each group. This calculation method is shown in the following Eq. (1).

Ao=ΣA(J)·F(N(j))/F(N(j)) (1)

where Ao : average value

A(j): average density of group j

N(j): number of pixels of group j

In this case, it is preferred that γ of the leg (shaded portion) be calculated from the gradation equivalent to the subject reflection density of 1.0 or more; more preferably, 1.2 or more; still more preferably, 1.4 or more. It is preferred that γ of the shoulder (highlighted portion) be calculated from the gradation equivalent to the subject reflection density of 0.4 or less; more preferably, 0.3 or less; still more preferably, 0.2 or less. It is preferred that γ of the middle portion be calculated from the gradation equivalent to the subject reflection density of 0.6 through 0.8; more preferably, 0.65 through 0.75; still more preferably, 0.7.

Returning to FIG. 1, the condition optimizing means 6a allows the image data to undergo hard gradation processing based on the γ of the image data normalized by the normalizing processing means 4a, and chroma decreasing processing or chroma enhancing processing based on the chroma of the image data normalized. The following describes the details of the process for obtaining the curve (G) of the first quadrant (A) in FIG. 3 acquired by the condition optimizing means 6a.

The normalizing processing means 4a establishes the above-mentioned digital printer gradation setting as an initial value wherein, when a gray standard patch having a reflection density of 0.7 or reflection rate of 18% is used as a subject, and a photographic print is created from the image data obtained from the digital camera using a digital printer, adjustment has been made to ensure that the reflection density of the gray standard patch reproduced on the photographic print is 0.6 through 0.8 at all times (adjustment of a fixed point). Under this condition, the same density is obtained on the print only at the reflection density of “0.7” or reflection rate of 18%.

The condition optimizing means 6a provides conversion processing to get the same gradation γ and chroma. To put it more specifically, this is to find agreement with the curve (G) of the first quadrant in FIG. 3. In this case, gradation data of a chart containing multiple reflection densities having a central gray standard patch of a reflection density 0.7 or reflection rate 18% is obtained by photographing in advance, and is used for gradation setting for each digital camera having the above-mentioned initial value. If there is completely no initial value, a gradation characteristics curve created by using multiple gray pixels to be extracted from one or more image data items (other than a chart) is used for gradation compensation processing.

The result obtained by using the condition optimizing means 6a is output to the condition storing means 5a as the difference from the curve (G) or a setting parameter for image processing and is stored in the memory medium 23 for each camera type.

Accordingly, as the camera type is identified, the camera lens, exposure control and focusing performance can be included in the scope of image processing. This processing is also performed by the condition optimizing means 6a. These image processing conditions are also included in the data stored for each camera type.

Going back to FIG. 1, the visual image referred image data generating means 20a comprises user's preference identifying means 7a, output medium identifying means 8a, correction means for gradation compensation setting 9a, gradation compensation processing means 10a, color compensation means 11a, sharpness processing means 12a, noise processing means 13a and others.

Here the visual image referred image data refers to the digital image data used for such a display device as a CRT, liquid crystal device and plasma display, or the digital image data used by the output device to generate hard copy images on such an output medium as silver halide photographic paper, inkjet paper and thermal printer paper. Optimization processing is carried out to ensure that the optimum image can be obtained on such a display device as a CRT, liquid crystal device and plasma display, and such an output medium as silver halide photographic paper, inkjet paper and thermal printer paper.

The user's preference identifying means 7a obtains the numeral value and code value entered by the user using the setup menu or key of the digital camera 1a, and identifies the user's preference pattern (e.g. preference for soft gradation with higher level of lightness and lower level of chroma, or hard gradation with lower level of lightness and higher level of chroma) from the numeral value and code value entered above.

The output medium identifying means 8a obtains the numeral value and code value entered by the user using the setup menu or key of the digital camera 1a, and identifies the details of the user's order (e.g. type and size of the output medium) from the numeral value and code value entered above.

The correction means for gradation compensation setting 9a establishes the amount of compensation in LUT, based on the information identified by the user' preference identifying means 7a and output medium identifying means 8a. To put it more specifically, the correction means for gradation compensation setting 9a sets the average value of image data in such a way that the reflection density is 0.6 through 0.8 on an output medium and “γ” of the leg (shaded portion) and shoulder (highlighted portion) is smaller than that of the middle portion. To put it another way, it controls the gradation setting of the digital printer based on the average value to ensure that the average value of the image data is such that the reflection density reproduced on the photographic print is kept at 0.6 through 0.8 on an output medium at all times, when a photographic print is created using a digital printer from the image data obtained from the digital camera 1a. In this case, the shape of the gradation conversion curve is adjusted so that “γ” of the leg (shaded portion) and shoulder (highlighted portion) is smaller than that of the middle portion, and then outputting that data. In other words, this is a gradation setting method where setting is changed in response to the scene to be photographed. Further, it is more preferable to make the reflection density reproduced on the photographic print is kept at 0.65 through 0.75 on an output medium.

Image data was subjected to gradation compensation by the gradation compensation processing means 10a, based on the amount of compensation for gradation compensation setting determined by the correction means for gradation compensation setting 9a. The gradation compensation processing means 10a outputs the gradation-corrected image data to the color compensation means 11a and monitor 18a.

The image data gradation-corrected by the gradation compensation processing means 10a is subjected to color compensation by the color compensation means 11a. The sharpness processing means 12a provides the sharpness processing where the sharpness of the color-corrected image data is adjusted. The sharpness-processed image data is subjected to processing of noise reducing by the noise processing means 13a, and is putout to the printer 14a or CDR writing means 19a.

The following describes the process of determining the amount of compensation for gradation compensation setting to be executed by the visual image referred image data generating means 20a.

For the configuration of the configuration of the image processing apparatus 21a according to the image forming method of the embodiment in the present invention shown in FIG. 1, the input means 16a reads the information on user's preference and/or information on output medium.

When only the information on user's preference is to be read, the input means 16a reads the information on user's preference as the numeral value and code value entered by the user using the setup menu or key of the digital camera 1a. Based on the numeral value and code value entered, the user' preference identifying means 7a determines the user's preference pattern, e.g. preference for soft gradation with higher level of lightness and lower level of chroma, or hard gradation with lower level of lightness and higher level of chroma. If preference for soft gradation with higher level of lightness and lower level of chroma has been determined, the correction means for gradation compensation setting 9a determines the amount of compensation in LUT, for example, the amount of LUT parallel movement of 3% and the reduced amount γ at intermediate brightness of 10%.

When only the information on output medium is to be read, the input means 16a reads the information on output medium, for example, the numeral value and code value entered by the user using the setup menu or key of the digital camera 1a. Based on the numeral value and code value entered, the output medium identifying means 8a identifies the information on the type and size of the print ordered by the user, for example, silver halide photographic print of L size (89×127 mm) (displayed as “photographic print” on the menu), A4-sized inkjet print, CD-R writing according to a predetermined resolution setting or index print of a predetermined size. Here if the silver halide photographic print of L size size (89×127 mm) is identified, there is no compensation. If an A4-sized inkjet print is identified, the amount of compensation in LUT, e.g. the amount of LUT chroma enhancement of 5% and the reduced amount γ at intermediate brightness, is determined by the correction means for gradation compensation setting 9a.

When both information on user's preference and information on output medium are to be read, the input means 16a reads the information on output medium, for example, the numeral value and code value entered by the user using the setup menu or key of the digital camera 1a as the information on user's preference. Based on the numeral value and code value entered, the user' preference identifying means 7a determines the user's preference pattern, e.g. preference for soft gradation with higher level of lightness and lower level of chroma, or hard gradation with lower level of lightness and higher level of chroma. The obtained result of identification is output to the correction means for gradation compensation setting 9a.

The output medium identifying means 8a identifies the information on the type and size of the print ordered by the user, for example, silver halide photographic print of L size (89×127 mm) (displayed as “photographic print” on the menu), A4-sized inkjet print, CD-R writing according to a predetermined resolution setting or index print of a predetermined size. The obtained result of identification is output to the correction means for gradation compensation setting 9a. Then the correction means for gradation compensation setting 9a determines the amount of compensation in LUT stored in the memory in advance in combination with these results of identification.

When the amount of compensation in LUT has been determined by the correction means for gradation compensation setting 9a, gradation is corrected by the gradation compensation processing means 10a.

The gradation compensation processing means 10a determines a common target value for each camera type and calculates a set value close to the target value. One of the digital cameras for professional use is as follows: Processing of hard gradation is carried out in such a way that the y of a straight line connecting the leg (shaded portion) and shoulder (highlighted portion) is about 1.1 through 1.6 around the image data value of the gray standard patch having a reflection density of “0.7” or reflection rate of 18% where the reflection density on the photographic print is produced within the range from 0.6 through 0.8 at all times. In this case, the gradation characteristic curve created by using multiple gray pixels extracted from one or more items of image data is preferred to be utilized to process gradation compensation from the viewpoint of improving the accuracy. It is preferred perform color compensation at the same time in order to correct the chroma that has been intensified with the processing of hard gradation. Here the gray pixel is defined as the one having recorded the gray area of a subject.

To reduce the difference from the photographic print created from a negative film, it is preferred to carry out the processing of making granularity and sharpness closely analogous to those of the photographic print using the evaluation scale created by normalization in terms of the sensory value by sensory evaluation.

To put it more specifically, the power spectrum obtained by frequency analysis of the image data is plotted against the frequency, and inclination per unit obtained by connecting two points, 10 cycles/mm and 20 cycles/mm, is assumed as “mg” and “mr”. Then the sharpness for each level of brightness is obtained from the following Eq. (2).

M=7.0×Log10(mg×29.4+mr×12.6+40)−10 (2)

Further, the average value of the standard deviation obtained by averaging the image in terms of each smaller block is G and R, which are assumed as “SDg” and “SDr”, respectively. The granularity is found from each numerical value as follows.

ng=−7.0×Log10(9.9×SDg−11)+15.5

nr=−7.0×Log10−(9.9×SDr−11)+15.5

The average is found as follows.

N=(7×ng+×nr)/11

From the calculated values, M and N, the overall image quality value (value Q) is worked out.

Eq. Q=(0.413×M(−3.4)+0.422×N(−3.4))(−1/3.4)−0.532

As described above, when calculation is made of the image processing conditions for making value Q of a photographic print closely analogous to that of the image data of a digital camera, the difference between the two is reduced, and they will become more closely analogous with each other from a subjective point of view.

The gradation-corrected image data is displayed on the CRT monitor 18a, and is verified by an operator. If it has been determined that further compensation is desirable, the operator makes compensation using the setup menu or key of the input means 17a. The numeral value and code value entered by the operator are output to the correction means for gradation compensation setting 9a, and the amount of compensation in LUT is again determined by the correction means for gradation compensation setting 9a. The mount of LUT compensation determined in this manner is output to the gradation compensation processing means 10a, and the image data is again subjected to gradation compensation. The gradation-compensated image data is displayed on the CRT monitor 18a, and the desired quality level is checked by the operator.

When the above-mentioned setting of photographing conditions, information on the subject, information on the user's preference and information on output medium are all recorded as tag information for the image data, it is also possible to arrange such a configuration that the above-mentioned tag information is read by the header analysis means 16b of the image processing apparatuses 21b according to the image forming method of the embodiment in the present invention. Here the standard recorded as tag information includes such known formats as “Baseline Tiff Rev. 6.0 RGB Full Color Image” adopted as a non-compressed file of the Exif file and compressed data file format conforming to the JPEG, for example.

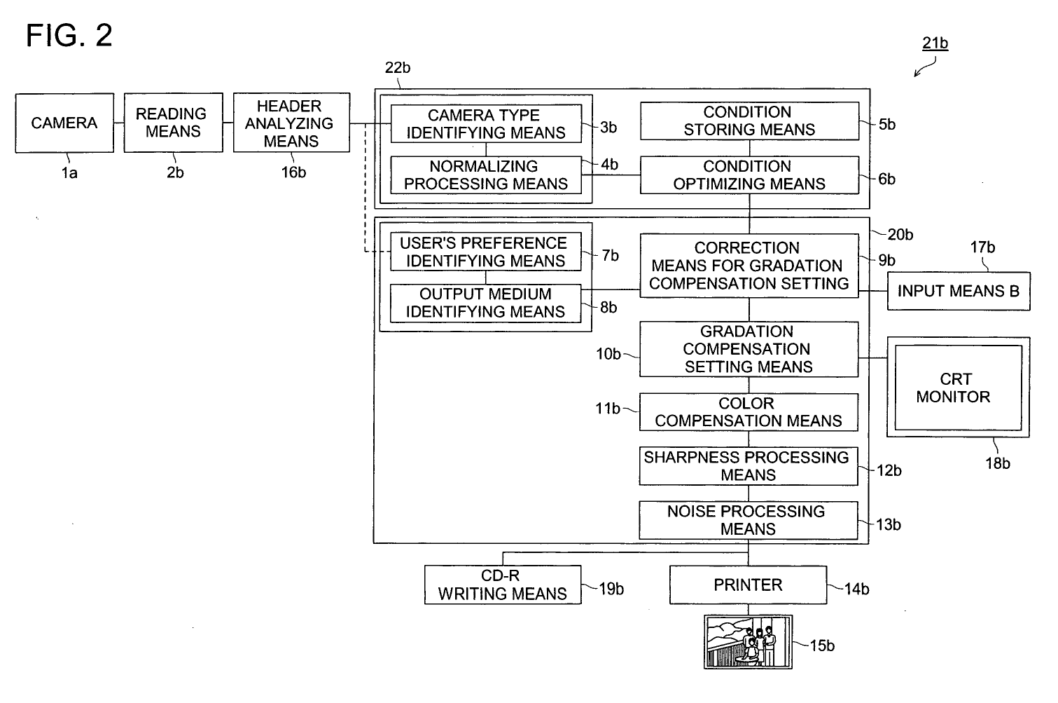

The image processing apparatus 21a in FIG. 2 has approximately the same configuration as that of the image processing apparatus 21a in FIG. 1 in details except for the header analysis means 16b. So the same configuration will be assigned with the same numerals of reference, and will not be described to avoid duplication.

In the configuration of the image processing apparatuses 21a and 21b according to the image forming method of the embodiment in the present invention. When the user directly enters the information on the user's preference recorded by the camera and information on the output medium by the input means 16a and header analysis means 16 using the image processing apparatuses 21a and 21b, without the user' preference identifying means 7a and 7b and output medium identifying means 8a and 8b getting get the information on the user's preference recorded by the camera and information on the output medium by the input means 16a and header analysis means 16b, then the input means 17a and 17b has a function for directly entry by the user.

The following describes the operation of an embodiment according to the present invention.

FIG. 4 is a flowchart representing the image formation carried out by the image processing apparatuses 21a and 21b the present embodiment according to the present invention:

The reading means 2a and 2b reads image data from the memory card recording the image data obtained by photographing an subject using the digital camera 1a (Step S1). Then the input means 16a reads the information attached to the image data; alternatively, the header analysis means 16b performs header analysis of reading the tag information, and records in the memory medium 23 the information having been read on the camera type, user's preference and output medium, and other photographing conditions, e.g. exposure time, shutter speed, f-stop number (F number), ISO sensitivity, brightness value, subject distance range, light source, lighting or non-lighting of stroboscopic lamp, subject area, white balance, zooming magnification, subject composition, photographed scene type, the amount of reflected light of stroboscopic light source and photographing chroma (Step S2).

Then the camera type identifying means 3a combines the above-mentioned tag information independently or in combination as a composite entity to identify the camera type (Step S3). Based on the result of identifying the result of camera type, the condition optimizing means 6a determines if the optimization processing conditions for image processing are stored in the memory medium 23 or not (Step S4). If these conditions are present, it reads the optimization processing conditions from the memory medium 23 (Step S24), and carries out the processing of gradation compensation and color compensation (Step S9).

If the optimization processing conditions are not present in the memory medium 23, the normalizing processing means 4a reads the normalizing processing conditions from the memory medium 23 and carries out normalizing processing (Step S5). In this case, normalizing processing conditions are created for each manufacturer, not for each device model.

The condition optimizing means 6a and 6b determines from the image data if the y is appropriate or not (Step S6). If gradation is softer than a predetermined value, gradation-hardening processing is carried out (Step S7), and if gradation is harder than a predetermined value, gradation-softening processing is carried out (Step S8). Further, the condition optimizing means 6a and 6b determines if chroma is appropriate or not (Step S11). If the chroma is higher that a predetermined value, processing of chroma decreasing is carried out (Step S20). If the chroma is lower that a predetermined value, processing of chroma enhancing is carried out (Step S21). The optimized gradation compensation processing conditions and color compensation processing conditions are stored in the memory medium 23 for each camera type (Step S22).

Then the correction means for gradation compensation setting 9a evaluates the information on user's preference; for example, it determines if a numerical value or code value entered by the user using the setup menu or key is present or not (Step S10). Then it evaluates the information on output medium; for example, it determines if a numerical value or code value entered by the user using the setup menu or key is present or not (Step S13). If it is present, it examines the amount of compensation in LUT (for example, the amount of LUT parallel movement and the reduced amount of y) from the viewpoint of both the user's preference and output medium, thereby working out (it calculates according to the gradation compensation table) the amount of compensation (Step S14). Based on the calculated amount of compensation, the gradation compensation table is corrected (Step S15).

If there is no information on the output medium, only the information on user's preference is used to determine the amount of compensation in LUT, and the gradation compensation table is corrected (Step S15). If there is no information on the user's preference, check is made to see if there is information on output medium (Step S13). If there is such information, the amount of compensation in LUT is determined and the gradation compensation table is corrected (Step S15). Further, if there is no information on output medium, the gradation compensation table is established from the information obtained so far (Step S16).

It is also possible to arrange such a configuration that the condition table (not illustrated) and others stored in the memory medium 23 in advance are read out whenever required, and the amount of compensation in LUT is determined. Based on the gradation compensation table created by the above-mentioned processing, the gradation compensation processing means 10a corrects the gradation of the image data (Step S17), and the gradation-corrected image data is subjected to color compensation by the color compensation means 11a (Step S18).

As described above, the image processing apparatuses 21a and 21b in the embodiment of the present invention correct the difference in the captured image data output from the digital camera 1a among varied models, using the gradation compensation table normalized for each model of the digital camera 1a, and create a print in such a way that the average value of the data has a predetermined density on the print.

To put it another way, paying attention to the importance of the scene-referred image data in eliminating the factors deteriorating the high quality of an output print and achieving the high quality, the present inventors have established the minimum reference point for graduation setting according to the numeral standard in order to reproduce the image data closer to the scene-referred image data where the differences among varied models of digital camera have been corrected for all the factors related to the image quality in the present invention.

Accordingly, since an error except for the above-mentioned reference point can be tolerated in the compensation of the differences among varied models in color reproducibility and sharpness, a considerable degree of freedom is ensured. It is clear, as a result, that differences among varied models are reduced for the entire factor related to picture quality.

In the beginning, the present inventors have defined the high quality in the digital exposure silver halide photographic print as follows: (1) There should be no sense of incompatibility with the silver halide print created from the negative and it must be acceptable to a user. (2) The user's intention and preference must be adequately reflected. (3) Observation conditions in response to the changes in the type and size of an output medium must have been compensated in order to conform to user's subjective evaluation.

To achieve the target of the above-mentioned image quality, the process of generating the visual image referred image data from the captured image data is divided into the following two steps; (1) a step of generating the normalized digital image data (scene-referred image data) characterized by a higher level of reference to the photographed scene, and (2) a step of creating the digital image data (visual image referred image data) optimized to meet the viewing conditions from the scene-referred image data. This is the greatest characteristic of the present invention.

The present invention finds advantages in the former normalized digital image data (scene-referred image data) characterized by a higher level of reference to the photographed scene. This digital image data can be stored in the medium such as CD-R to be presented to a user for viewing mainly on the CRT display monitor. In this case, it is also possible to arrange such a configuration that the scene-referred image data and the image processing conditions for generating the visual image referred image data from the scene-referred image data are stored in a medium and presented to the user in such a way that the user is responsible for final image formation.

The present invention is also characterized in that the user's preference and type and size of the output medium are reflected on the viewing image data that can be used for viewing mainly on the CRT display monitor. It is known that, when a hard copy is created in a silver halide photographic print, its finished image quality is often compared with that of the silver halide photographic print created from a negative. Thus, the present invention is further characterized in that the LATD (Average Transmission Density) control method based on the principle of Evans where the average value of an entire image used in the generation of a silver halide photographic print from a negative is finished to a predetermined density is adopted as a gradation compensation method dependent on a photographed scene.

From the above description, it is apparent that the present invention reduces the differences in image quality from the photographic print created from the negative carrying the image of the same photographed subject, and provides a more preferred photographic print suited to the user's preference and output medium. To put it another way, the present invention provides an output print standardized in gradation setting from the image data acquired from digital cameras of varied models according to the image processing method disclosed in the Official Gazettes of Japanese Patents Laid-Open Nos. 2002-19807 and 2002-16821. Not only that, in order to remove the factors that deteriorate the high quality of an output print and to achieve high image quality, the present invention sets the minimum reference point in gradation setting according to the numerical standard, thereby solving the problem of a gradation adjustment error occurring depending on a subject in the above-mentioned conventional image processing method. Thus, achieving the high-precision agreement ranging from shadow to highlight and eliminating the differences among varied models in color reproducibility and sharpness, the present invention provides a high-quality photographic print.

The above-mentioned description refers to preferred embodiments of the present invention. However, the present invention is not restricted to the above-mentioned embodiments. Components of the above-mentioned image processing apparatuses 21a and 21b and processing procedures can be modified as required, without departing from the spirit of the prevent invention.

### EFFECTS OF THE INVENTION

In image processing for eliminating the differences among varied models for each photographed apparatus, the present invention solves the problem of a gradation adjustment error occurring depending on a subject, and achieves high-precision agreement ranging from shadow to highlight. It further eliminates the differences among varied models in color reproducibility and sharpness, thereby ensuring a high-quality photographic print. Thus, the present invention provides a photographic print of a digital camera characterized by minimized differences in image quality from the photographic print created from the negative carrying the image of the same photographed subject.

What is claimed is:

1. An image forming method for forming visual image referred image data by subjecting captured image data, which have been recorded by an image-capturing device, to predetermined image processing of optimization to form an image for viewing on an output medium, comprising:
identifying a type of the image-capturing device;
generating a scene-referred image data by subjecting the image data, obtained by photographing a subject having a reflection density of 0.7, to normalizing processing for each type of the image-capturing device, wherein the normalizing processing ensures that the reflection density on the output medium becomes 0.6 through 0.8;
optimizing conditions of the predetermined image processing using the scene-referred image data to obtain optimized image processing conditions;
storing the optimized image processing conditions for each type of the image-capturing device;
subjecting the image data obtained by applying the optimized image processing conditions to gradation compensation processing, which ensures that the average value of the image data is outputted on an output medium to have the reflection density of 0.6 through 0.8 and γ values of the leg (shaded portion) and the shoulder (highlighted portion) are smaller than that of the middle portion of the outputted image, and
outputting the image data having been subjected to the gradation compensation processing.

2. The image forming method of claim 1, wherein in the step of optimizing conditions of the predetermined image processing, information on user's preference is further used, as well as the scene-referred image data, to obtain optimized image processing conditions.

3. The image forming method of claim 1, wherein in the step of optimizing conditions of the predetermined image processing, information on the output medium is further used, as well as the scene-referred image data, to obtain optimized image processing conditions.

4. The image forming method of claim 1, wherein in the step of optimizing conditions of the predetermined image processing, information on user's preference and information on the output medium is further used, as well as the scene-referred image data, to obtain optimized image processing conditions.

5. The image forming method of claim 2, wherein the information on user's preference is the information attached to the captured image data.

6. The image forming method of claim 2, wherein the information on user's preference is the information inputted by a user.

7. The image forming method of claim 2, wherein the information on user's preference is at least one of the pieces of information on setting of image data gradation.

8. The image forming method of claim 3, wherein the information on the output medium is the information attached to the captured image data.

9. The image forming method of claim 3, wherein the information on an output medium is the information inputted by a user.

10. The image forming method of claim 3, wherein the information on the output medium comprises one of the information on the type and the information on the size of the output medium.

11. The image forming method of claim 1, wherein in the step of identifying a type of image-capturing device, the information attached to the captured image data is used.

12. The image forming method of claim 11, wherein the information attached to the captured image data is information indicating a model of the image-capturing device.

13. The image forming method of claim 11, wherein the information attached to the captured image data is tag information indicating image-capturing conditions setting, and the type of the image-capturing device is identified through estimation by using the tag information.

14. The image forming method of claim 1, wherein the predetermined image processing comprises at least one of gradation compensation processing and color compensation processing.

15. An image processing apparatus for forming visual image referred image data by subjecting captured image data, which have been recorded by an image-capturing device, to predetermined image processing of optimization to form an image for viewing on an output medium, comprising:
a type identifying section for identifying a type of the image-capturing device;
a scene-referred image data generating section for generating a scene-referred image data by subjecting the image data, obtained by photographing a subject having a reflection density of 0.7, to normalizing processing for each type of the image-capturing device, wherein the normalizing processing ensures that the reflection density on the output medium becomes 0.6 through 0.8;
a condition optimizing section for optimizing conditions of the predetermined image processing by using the scene-referred image data to obtain optimized image processing conditions;
a storage section for storing the optimized image processing conditions for each type of the image-capturing device;
an image processing section for subjecting the image data obtained by applying the optimized image processing conditions to gradation compensation processing, which ensures that the average value of the image data is outputted on an output medium to have the reflection density of 0.6 through 0.8 and γ values of the leg (shaded portion) and the shoulder (highlighted portion) are smaller than that of the middle portion of the outputted image, and
an output section for outputting the image data having been subjected to the gradation compensation processing.

16. The image processing apparatus of claim 15, wherein the condition optimizing section optimizes the conditions of the predetermined image processing by further using information on user's preference, as well as the scene-referred image data.

17. The image processing apparatus of claim 15, wherein the condition optimizing section optimizes the conditions of the predetermined image processing by further using information on the output medium, as well as the scene-referred image data.

18. The image processing apparatus of claim 15, wherein the condition optimizing section optimizes the conditions of the predetermined image processing by further using information on user's preference and information on the output medium, as well as the scene-referred image data.

19. The image processing apparatus of claim 16, wherein the information on the output medium is the information attached to the captured image data.

20. The image processing apparatus of claim 16, further comprising a first information acquiring section for acquiring information on user's preference, wherein the information on user's preference is the information entered by a user using the first information acquiring section.

21. The image processing apparatus of claim 16, wherein the information on user's preference is at least one of the pieces of information on setting of image data gradation.

22. The image processing apparatus of claim 17, wherein the information on the output medium is the information attached to the captured image data.

23. The image processing apparatus of claim 15, further comprising a second information acquiring section for acquiring information on the output medium, wherein the information on the output medium is the information entered by a user using the second information acquiring section.

24. The image processing apparatus of claim 17, wherein the information on the output medium comprises one of the information on the type and the information on the size of the output medium.

25. The image processing apparatus of claim 15, wherein the type identifying section identifies the type of the image-capturing device by using the information attached to the captured image data.

26. The image processing apparatus of claim 25, wherein the information attached to the captured image data is information indicating a model of the image-capturing device.

27. The image processing apparatus of claim 25, wherein the information attached to the captured image data is tag information indicating image-capturing conditions setting, and the type identifying section identifies the type of the image-capturing device through estimation by using the tag information.

28. The image processing apparatus of claim 15, wherein the predetermined image processing comprises at least one of gradation compensation processing and color compensation processing.

29. A print forming apparatus for forming a print by using visual image referred image data, which are obtained by subjecting captured image data, recorded by an image-capturing device, to predetermined image processing of optimization to form an image for viewing on an output medium, comprising:
a type identifying section for identifying a type of the image-capturing device;
a scene-referred image data generating section for generating a scene-referred image data by subjecting the image data, obtained by photographing a subject having a reflection density of 0.7, to normalizing processing for each type of the image-capturing device, wherein the normalizing processing ensures that the reflection density on the output medium becomes 0.6 through 0.8;
a condition optimizing section for optimizing conditions of the predetermined image processing by using the scene-referred image data to obtain optimized image processing conditions;
a storage section for storing the optimized image processing conditions for each type of the image-capturing device;
an image processing section for subjecting the image data, obtained by applying the optimized image processing conditions, to gradation compensation processing, which ensures that the average value of the image data is outputted on an output medium to have the reflection density of 0.6 through 0.8 and γ values of the leg (shaded portion) and the shoulder (highlighted portion) are smaller than that of the middle portion of the outputted image, and
a printing section for forming a print by using the image data having been subjected to the gradation compensation processing.

30. The print forming apparatus of claim 29, wherein the condition optimizing section optimizes the conditions of the predetermined image processing by further using information on user's preference, as well as the scene-referred image data.

31. The print forming apparatus of claim 29, wherein the condition optimizing section optimizes the conditions of the predetermined image processing by further using information on the output medium, as well as the scene-referred image data.

32. The print forming apparatus of claim 29, wherein the condition optimizing section optimizes the conditions of the predetermined image processing by further using information on user's preference and information on the output medium, as well as the scene-referred image data.

33. The print forming apparatus of claim 30, wherein the information on the output medium is the information attached to the captured image data.

34. The print forming apparatus of claim 30, further comprising a first information acquiring section for acquiring information on user's preference, wherein the information on user's preference is the information entered by a user using the first information acquiring section.

35. The print forming apparatus of claim 30, wherein the information on user's preference is at least one of the pieces of information on setting of image data gradation.

36. The print forming apparatus of claim 31, wherein the information on the output medium is the information attached to the captured image data.

37. The print forming apparatus of claim 31, further comprising a second information acquiring section for acquiring information on the output medium, wherein the information on the output medium is the information entered by a user using the second information acquiring section.

38. The print forming apparatus of claim 31, wherein the information on the output medium comprises one of the information on the type and the information on the size of the output medium.

39. The print forming apparatus of claim 29, wherein the type identifying section identifies the type of the image-capturing device by using the information attached to the captured image data.

40. The image processing apparatus of claim 29, wherein the information attached to the captured image data is information indicating a model of the image-capturing device.

41. The image processing apparatus of claim 29, wherein the information attached to the captured image data is tag information indicating image-capturing conditions setting, and the type identifying section identifies the type of the image-capturing device through estimation by using the tag information.

42. The print forming apparatus of claim 29, wherein the predetermined image processing comprises at least one of gradation compensation processing and color compensation processing.

43. A memory medium for storing a computer-readable program code for forming visual image referred image data by subjecting captured image data, which have been recorded by an image-capturing device, to predetermined image processing of optimization to form an image for viewing on an output medium, the computer-readable program code comprising:
a type identifying program code for identifying a type of the image-capturing device;
a scene-referred image data generating program code for generating a scene-referred image data by subjecting the image data, obtained by photographing a subject having a reflection density of 0.7, to normalizing processing for each type of the image-capturing device, wherein the normalizing processing ensures that the reflection density on the output medium becomes 0.6 through 0.8;
a condition optimizing program code for optimizing conditions of the predetermined image processing by using the scene-referred image data to obtain optimized image processing conditions;
a storage program code for storing the optimized image processing conditions for each type of the image-capturing device;
an image processing program code for subjecting the image data obtained by applying the optimized image processing conditions to gradation compensation processing, which ensures that the average value of the image data is outputted on an output medium to have the reflection density of 0.6 through 0.8 and y values of the leg (shaded portion) and the shoulder (highlighted portion) are smaller than that of the middle portion of the outputted image, and
an output program code for outputting the image data having been subjected to the gradation compensation processing.

44. The memory medium of claim 43, wherein the condition optimizing program code is a code for optimizing the conditions of the predetermined image processing by further using information on user's preference, as well as the scene-referred image data.

45. The memory medium of claim 43, wherein the condition optimizing program code is a code for optimizing the conditions of the predetermined image processing by further using information on the output medium, as well as the scene-referred image data.

46. The memory medium of claim 43, wherein the condition optimizing program code is a code for optimizing the conditions of the predetermined image processing by further using information on user's preference and information on the output medium, as well as the scene-referred image data.
